(19) United States
(12) Patent Application Publication
(10) Pub. No.: US 2023/0343484 A1
(43) Pub. Date: Oct. 26, 2023

(54) CABLES WITH CORRUGATED DIELECTRIC ARMOR CONFIGURED TO PROVIDE ENHANCED CRUSH RESISTANCE AND/OR BENDING PERFORMANCE

(71) Applicant: BELDEN INC., St. Louis, MO (US)

(72) Inventor: James J. ZIMNICKI, Richmond, IN (US)

(73) Assignee: BELDEN INC., St. Louis, MO (US)

(21) Appl. No.: 18/139,283

(22) Filed: Apr. 25, 2023

Related U.S. Application Data
(60) Provisional application No. 63/334,541, filed on Apr. 25, 2022.

(51) Int. Cl. G02B 6/44; H01B 7/18

(52) U.S. Cl. CPC H01B 7/184; G02B 6/443

(57) ABSTRACT

An armored cable may include a cable core including at least one transmission element and a corrugated armor configured to surround the cable core. The corrugated armor may be configured to include raised portions and recessed portions along a length of the cable, the raised portions may be configured to be separated from one another by exterior grooves, and the recessed portions may be configured to be separated from one another by interior grooves. One of the raised portions may be connected to one of the recessed portions by a radial wall that may be configured to provide the corrugated armor with enhanced crush resistance.

### CROSS-REFERENCE TO RELATED APPLICATION

This application claims the benefit of U.S. Provisional Application No. 63/334,541 filed Apr. 25, 2022, the disclosure of which is hereby incorporated by reference herein in its entirety.

### FIELD

The present application relates to armored cables. In particular, the present application relates to cables having a corrugated dielectric armor or jacket for protecting and limiting the bend radius of the cable.

### BACKGROUND

Cables, including coaxial copper or fiber optic cables, multi-conductor cables including twisted pair cables or fiber optic bundles, or any other such type of cables, may be jacketed or encapsulated in a protective coating or armor of a material, such as metal, silicone rubber, polyvinyl chloride (PVC), polytetrafluoroethylene (PTFE or Teflon), polyvinylidene fluoride (PVDF), fluorine resin, or any other such material. Thicker armor or jackets provide greater protection for the interior cables, but may be significantly heavier and stiffer, and thus may be difficult and/or more expensive to install. Also, metallic armor typically requires additional hardware and/or installation procedures for grounding such metallic armor to meet safety standards, thus making installation time-consuming and expensive.

In some implementations, to reduce weight of the cable and/or provide enhanced flexibility, the armor or jacket may be undulated or notched with grooves, which may be annular rings, helical spirals, or have other such profiles. Manufacturing of this undulated or grooved jacket or armor may be particularly difficult, however, due to stretching or compression and extension of the jacket, resulting in different lengths between the jacket and interior cables. Such implementations may require extensive re-normalization processes to readjust the jacket or armor and interior cables, which may add significant manufacturing expense, extend assembly lines, and slow down manufacturing processes. Current manufacturing processes may also limit the size of the cable and/or jacket or armor and may be limited in material selection.

It may be desirable to provide a cable with corrugated dielectric armor configured to provide improved or enhanced crush resistance, crush resistance-to-weight ratio, and/or bending performance relative to conventional armored cable. It may be desirable to provide a cable with corrugated dielectric armor having a greater range of cable sizes (smaller and/or larger) relative to conventional armored cable. It may be desirable to provide a cable with corrugated dielectric armor configured to be produced in fewer process steps, with versatile processing speeds, with different jacket materials, and/or with a reduced amount of extrusion material relative to conventional armored cable. It may be desirable to provide an armor without metallic components that need to be grounded when used in the field. It may be desirable to provide a cable with corrugated dielectric armor having improved lifespan relative to conventional armored cable. It may be desirable to provide a dielectric armor that can provide a water-tight barrier, which may not be feasible with conventional interlocked armoring methods.

### SUMMARY

According to various embodiments of the disclosure, a cable core may include at least one transmission element and a corrugated dielectric armor configured to surround the cable core. The at least one transmission element may include an optical fiber or a conductor. The corrugated dielectric armor may comprise a material having a melt flow rate of 0.5-20 g/10 min. at 230° C. to 240° C. so as to permit the corrugated dielectric armor to be used in higher stability melt applications, and the material of the corrugated dielectric armor may comprise a static coefficient of friction of 0.18 to 0.44 and a dynamic coefficient of friction of 0.12 to 0.32 versus steel at 73° F. so as to enhance pulling and/or pushing of the corrugated dielectric armor during installation. The corrugated dielectric armor may be configured to include raised portions and recessed portions along a length of the cable, the raised portions may be configured to be separated from one another by exterior grooves, the recessed portions may be configured to be separated from one another by interior grooves, and the exterior grooves may be configured to have a groove length in the longitudinal direction. Each of the raised portions may be configured to include an exterior land having a land length, the exterior lands may be configured to delimit an outer diameter of the corrugated dielectric armor, each of the recessed portions may be configured to include an interior land, and the interior lands may be configured to delimit an inner diameter of the corrugated dielectric armor. The land length of the raised portions may be configured to be greater than the groove length of the exterior grooves so as to prevent nesting of the cable, and opposing corners of adjacent raised portions may be configured to define bend limiting contact points that are configured to contact one another when the cable is bent so as to limit a degree to which the cable can be bent to a desired bend radius. One of the raised portions may be connected to one of the recessed portions by a radial wall that is configured to extend perpendicular to a longitudinal axis of the corrugated dielectric armor when the corrugated dielectric armor is in a straight configuration, and the radial wall may be configured to provide the corrugated dielectric armor with enhanced crush resistance.

In some aspects of the above embodiments, the material of the corrugated dielectric armor may comprise a polyvinylidene fluoride (PVDF) having a material melt flow rate of 0.5-20 g/10 min. at 230° C.

In some aspects of the above embodiments, the material of the corrugated dielectric armor may comprise a polyvinylidene fluoride (PVDF) having a static coefficient of friction of 0.18 to 0.23 and a dynamic coefficient of friction of 0.12 to 0.17 versus steel at 73° F.

In some aspects of the above embodiments, the material of the corrugated dielectric armor may comprise a thermoplastic polyester elastomer (TPC-ET) having a material melt flow index of 12.5 g/10 min. at 240° C.

In some aspects of the above embodiments, the material of the corrugated dielectric armor may comprise a thermoplastic polyester elastomer (TPC-ET) having a static coefficient of friction of 0.28 to 0.44 and a dynamic coefficient of friction of 0.22 to 0.32 versus steel at 73° F.

In some aspects of the above embodiments, the exterior grooves, the interior grooves, and/or the radial wall may be configured to provide the corrugated armor with an improved or enhanced crush resistance-to-weight ratio.

According to various embodiments of the disclosure, an armored cable may include a cable core including at least one transmission element and a corrugated dielectric armor configured to surround the cable core. The corrugated dielectric armor may be configured to include raised portions and recessed portions along a length of the cable, the raised portions may be configured to be separated from one another by exterior grooves, the recessed portions may be configured to be separated from one another by interior grooves, and the exterior grooves may be configured to have a groove length in the longitudinal direction. A land length of the raised portions may be configured to be greater than the groove length of the exterior grooves so as to prevent nesting of the cable, and opposing corners of adjacent raised portions may be configured to define bend limiting contact points that are configured to contact one another when the cable is bent so as to limit a degree to which the cable can be bent to a desired bend radius. One of the raised portions may be connected to one of the recessed portions by a radial wall that is configured to extend perpendicular to a longitudinal axis of the corrugated dielectric armor when the corrugated dielectric armor is in a straight configuration, and the radial wall may be configured to provide the corrugated dielectric armor with enhanced crush resistance.

In some aspects of the above embodiments, the corrugated dielectric armor may comprise a polyvinylidene fluoride (PVDF) having a material melt flow rate of 0.5-20 g/10 min. at 230° C. so as to permit the corrugated dielectric armor to be used in higher stability melt applications.

In some aspects of the above embodiments, the corrugated dielectric armor comprise a polyvinylidene fluoride (PVDF) having a static coefficient of friction of 0.18 to 0.23 and a dynamic coefficient of friction of 0.12 to 0.17 versus steel at 73° F. so as to enhance pulling and/or pushing of the corrugated dielectric armor during installation.

In some aspects of the above embodiments, the corrugated dielectric armor comprise a thermoplastic polyester elastomer (TPC-ET) having a material melt flow index of 12.5 g/10 min. at 240° C. so as to permit the corrugated dielectric armor to be used in higher stability melt applications.

In some aspects of the above embodiments, the corrugated dielectric armor comprise a thermoplastic polyester elastomer (TPC-ET) having a static coefficient of friction of 0.28 to 0.44 and a dynamic coefficient of friction of 0.22 to 0.32 versus steel at 73° F. so as to enhance pulling and/or pushing of the corrugated dielectric armor during installation.

In some aspects of the above embodiments, the at least one transmission element may include an optical fiber or a conductor.

In some aspects of the above embodiments, each of the raised portions may be configured to include an exterior land, the exterior lands may be configured to delimit an outer diameter of the corrugated dielectric armor; each of the recessed portions may be configured to include an interior land, and the interior lands may be configured to delimit an inner diameter of the corrugated dielectric armor.

In some aspects of the above embodiments, the exterior grooves, the interior grooves, and/or the radial wall may be configured to provide the corrugated armor with an improved or enhanced crush resistance-to-weight ratio.

According to various embodiments of the disclosure, an armored cable may include a cable core including at least one transmission element and a corrugated armor that may be configured to surround the cable core. The corrugated armor may be configured to include raised portions and recessed portions along a length of the cable, the raised portions may be configured to be separated from one another by exterior grooves, and the recessed portions may be configured to be separated from one another by interior grooves. One of the raised portions may be connected to one of the recessed portions by a radial wall that may be configured to provide the corrugated armor with enhanced crush resistance.

In some aspects of the above embodiments, the corrugated armor may comprise a polyvinylidene fluoride (PVDF) having a material melt flow rate of 0.5-20 g/10 min. at 230° C. so as to permit the corrugated armor to be used in higher stability melt applications.

In some aspects of the above embodiments, the corrugated armor may comprise a polyvinylidene fluoride (PVDF) having a static coefficient of friction of 0.18 to 0.23 and a dynamic coefficient of friction of 0.12 to 0.17 versus steel at 73° F. so as to enhance pulling and/or pushing of the corrugated armor =during installation.

In some aspects of the above embodiments, the corrugated armor may comprise a thermoplastic polyester elastomer (TPC-ET) having a material melt flow index of 12.5 g/10 min. at 240° C. so as to permit the corrugated armor to be used in higher stability melt applications.

In some aspects of the above embodiments, the corrugated armor may comprise a thermoplastic polyester elastomer (TPC-ET) having a static coefficient of friction of 0.28 to 0.44 and a dynamic coefficient of friction of 0.22 to 0.32 versus steel at 73° F. so as to enhance pulling and/or pushing of the corrugated armor during installation.

In some aspects of the above embodiments, the at least one transmission element may include an optical fiber or a conductor.

In some aspects of the above embodiments, each of the raised portions may be configured to include an exterior land, the exterior lands may be configured to delimit an outer diameter of the corrugated armor, each of the recessed portions may be configured to include an interior land, and the interior lands may be configured to delimit an inner diameter of the corrugated armor.

In some aspects of the above embodiments, the exterior grooves may be configured to have a groove length in the longitudinal direction, and a land length of the raised portions may be configured to be greater than the groove length of the exterior grooves so as to prevent nesting of the cable.

In some aspects of the above embodiments, opposing corners of adjacent raised portions may be configured to define bend limiting contact points that are configured to contact one another when the cable is bent so as to limit a degree to which the cable can be bent to a desired bend radius.

In some aspects of the above embodiments, the corrugated armor may comprise a corrugated dielectric armor.

In some aspects of the above embodiments, the exterior grooves, the interior grooves, and/or the radial wall may be configured to provide the corrugated armor with an improved or enhanced crush resistance-to-weight ratio.

The foregoing and other features of construction and operation of the embodiments will be more readily understood and fully appreciated from the following detailed disclosure, taken in conjunction with accompanying drawings.

### BRIEF DESCRIPTION OF THE FIGURES

FIG. 1 is a cross-sectional view of an exemplary embodiment of a cable having a corrugated dielectric armor in accordance with various aspects of the disclosure;

FIG. 2 is a cross-sectional view of the cable of FIG. 1 shown in a bent configuration;

FIG. 3 is a cross-sectional view of the corrugated dielectric armor of the cable of FIG. 1 shown in the bent configuration of FIG. 2;

FIG. 4A is a cross-sectional view of an exemplary embodiment of a cable having a corrugated dielectric armor in accordance with various aspects of the disclosure;

FIG. 4B is a cross-sectional view taken along line IV-IV of FIG. 4A;

FIG. 5A is a cross-sectional view of an exemplary embodiment of a cable having a corrugated dielectric armor in accordance with various aspects of the disclosure;

FIG. 5B is a cross-sectional view taken along line V-V of FIG. 5A;

FIG. 6A is a cross-sectional view of an exemplary embodiment of a cable having a corrugated dielectric armor in accordance with various aspects of the disclosure;

FIG. 6B is a cross-sectional view taken along line VI-VI of FIG. 6A;

FIG. 7A is a cross-sectional view of an exemplary embodiment of a cable having a corrugated dielectric armor in accordance with various aspects of the disclosure;

FIG. 7B is a cross-sectional view taken along line VII-VII of FIG. 7A;

FIG. 8A is a cross-sectional view of an exemplary embodiment of a cable having a corrugated dielectric armor in accordance with various aspects of the disclosure;

FIG. 8B is a cross-sectional view taken along line VIII-VIII of FIG. 8A; and

FIG. 9 is a cross-sectional view of another exemplary corrugated dielectric armor for a cable.

In the drawings, like reference numbers generally indicate identical, functionally similar, and/or structurally similar elements.

### DETAILED DESCRIPTION

As a preface to the detailed description, it should be noted that, as used in this specification and the appended claims, the singular forms “a,” “an,” and “the” include singular and plural referents, unless the context clearly dictates otherwise.

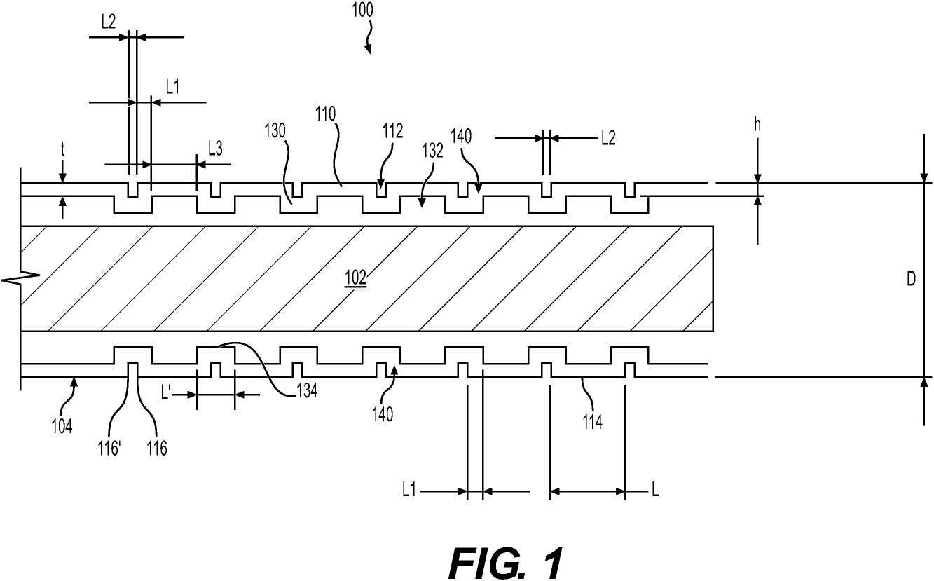

FIGS. 1-3 illustrate an exemplary cable 100 in accordance with various aspects of the disclosure. FIG. 1 is a cross section of the cable 100, viewed along the longitudinal axis X of the cable. The cable 100 includes a cable core 102 and a corrugated dielectric armor or jacket 104. The cable core 102 may include various core configurations, some nonlimiting examples of which are described in more detail below. The cable core 102 may be substantially circular in cross section or may be an oval or ellipsoid in various implementations. In some aspects, the cable core 102 may be axially fixed relative to the corrugated dielectric armor 104 such that the cable core 102 is configured to not slide axially relative to the corrugated dielectric armor 104.

The corrugated dielectric armor 104 includes raised portions 110 and recessed portions 130 along the length of the cable 100. The raised portions 110 and recessed portions 130 overlap one another in the longitudinal direction and an end of a raised portion 110 is connected to an end of recessed portion 130 by a radial wall 140 having a wall length L1. The raised portions 110 are separated from one another by exterior grooves 112, and the recessed portions 130 are separated from one another by interior grooves 132. The exterior grooves 112 have a groove length L2 in the longitudinal direction, and the interior grooves 132 have a groove length L3 in the longitudinal direction. The radial wall 140 extends perpendicular to a longitudinal axis of the corrugated armor 104 when the corrugated armor 104 is in a straight (i.e., unbent) configuration and is configured to provide the corrugated armor 104 with improved or enhanced crush resistance relative to conventional armored cable. In addition, the exterior grooves 112, the interior grooves 132, and/or the radial wall 140 are configured to provide the corrugated armor 104 with an improved or enhanced crush resistance-to-weight ratio relative to conventional armored cable.

Each of the raised portions 110 includes an outer surface or land 114 having a land length L. The exterior lands 114 delimit an outer diameter D of the cable 100. In some aspects, each of the exterior lands 114 has the same land length L. Each of the raised portions 110 has a radial thickness t. It should be appreciated that the radial thickness t of the raised portions 110 may be greater than, less than, or the same as a depth or height h of the exterior grooves 112.

In other aspects, the land lengths of the exterior lands may vary in accordance with desired design specifications. For example, varied land lengths may be used to set regular intervals where the cable should be cut for assembly or to create points at which connectors may be molded in place to such corrugations.

Each of the recessed portions 130 includes an inner surface or land 134 having a land length L′. The interior lands 134 delimit an inner diameter of the corrugated dielectric armor 104 sized and configured to receive the cable core 102. In some aspects, each of the interior lands 134 has the same land length L′. Each of the recessed portions 130 may also have the same or substantially the same radial thickness t as the raised portions 110. It should be appreciated that the radial thickness t of the recessed portions 130 may be greater than, less than, or the same as a depth or height h′ of the interior grooves 132.

In other aspects, the land lengths of the interior lands may vary in accordance with desired design specifications. For example, varied land lengths may be used to set regular intervals where the cable should be cut for assembly or to create points at which connectors may be molded in place to such corrugations.

In the embodiment depicted in FIGS. 1-3, the length L of the raised portions 110 is greater than the length L2 of the exterior grooves 112, which provides for ease of installation and prevents nesting of the cable 100. In other implementations, the raised portions 110 and the exterior grooves 112 may have a similar or identical length.

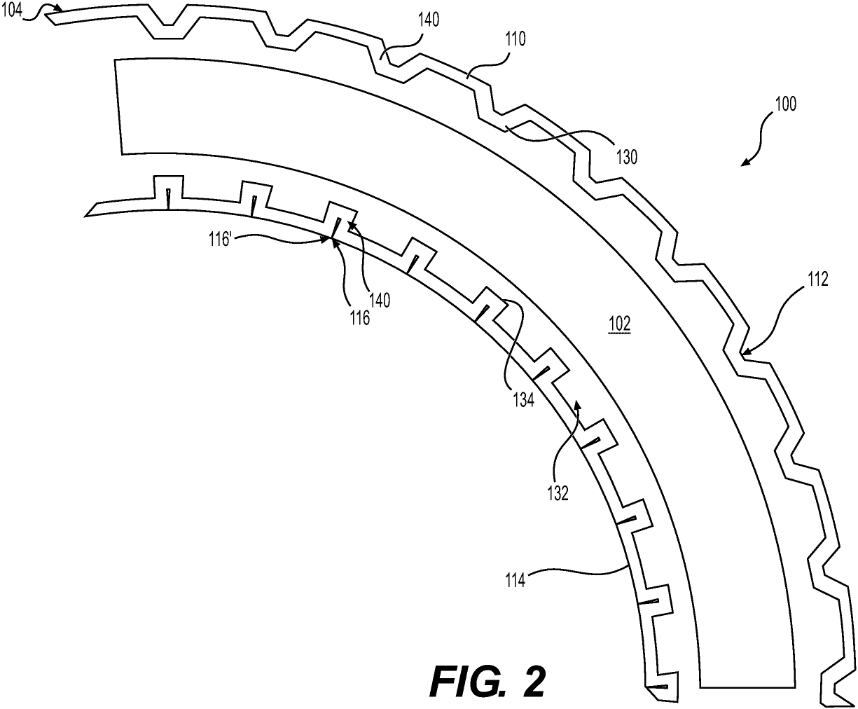

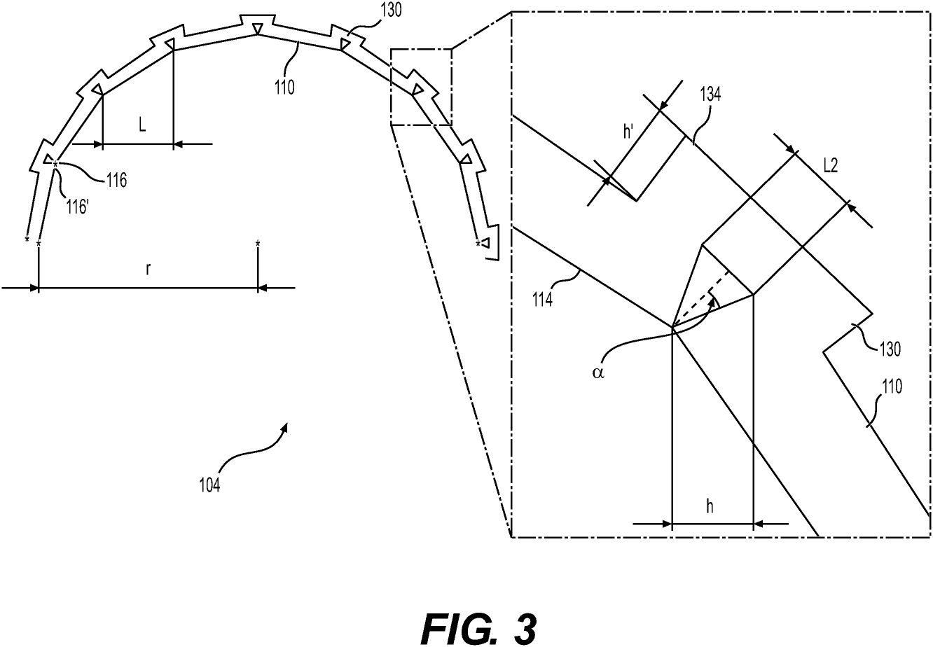

Opposing corners 116, 116′ of adjacent raised portions 110 define bend limiting contact points. That is, as best shown in FIG. 2, when the cable 100 is bent, the opposing corners 116, 116′ are configured to come into contact with one another and, in combination with the lengths of the exterior lands 114, are configured to limit the degree to which the cable 100 can be bent to a desired bend radius r (FIG. 3), for example, a minimum bend radius of the cable.

The cable core 102 may include various types of transmission elements, including coaxial copper or fiber optic cables, multi-conductor cables including twisted pair cables or fiber optic bundles, or any other such type of cables, and the desired bend radius r may depend on the type of cable jacketed by the corrugated dielectric armor 104. It should be appreciated that the cable core may comprise transmission elements that are untwisted, twisted in pairs or larger groups, individually insulated or jacketed, jacketed in pairs or larger groups, etc., fiber optic transmission elements including fully bonded, partially bonded, or flexible ribbon fibers, shields, braids, drain wires, strength yarns, interior jackets, fillers or cross-web separators, or a mix of these and or any other elements (e.g. hybrid power/fiber/communications cables, etc.) without limitation. For example, in some implementations, the cable core may comprise 6, 12, or 24 coated and partially-bonded optical fibers, or any other such number of fibers.

The corrugated dielectric armor 104 can be manufactured in accordance with desired parameters for the cable 100 and the cable core 102 in any application. For example, if a particular application requires an outer diameter D of 10 mm, a radial thickness t of the raised and recessed portions 110, 130 of 1 mm, a height h of the outer and interior grooves 112, 132 of 0.5 mm, a bend radius that is ten (10) times the outer diameter D of the cable 100 (10*D =100 mm), and a half-angle α (formed when the opposing corners 116, 116′ contact one another during bending) of 1°, then the raised portion land length L and the exterior groove length L2 can be determined, as well as various other parameters of the cable. The inner circumference of the bent cable 100 would be 628.319 mm (C = 2πr), the land length L would be 3.491 (L = C/(360/(2α))), and the exterior groove length L2 would be 1 mm (L2 = 2h*sin(α)). Further, an inside diameter defined by the raised portions 110 would be 8 mm, an inside diameter defined by the recessed portions 130 would be 7 mm, and an outside diameter defined by the recessed portions 130 would be 9 mm. Thus, this particular application of the cable 100 is configured to accommodate a cable core 102 having an outside diameter of 7 mm or less.

The corrugated dielectric armor 104 may be formed by an extrusion and vacuum molding/forming process. In such a process, a tube is extruded in the same fashion as any other tubing process. As mold blocks close around the extrusion melt, vacuum pressure applied around the extruded tube pulls the tube into a shape determined by the mold blocks. Positive pressure can also be forced to blow out the mold like a balloon. The present vacuum forming process is similar to other vacuum forming processes but, in the present process, the mold blocks “shuttle” or move in sync with the extrusion melt and size and shape the melt according to the size and shape of the mold blocks.

The armor 104 may be formed from any suitable material, including Teflon, PVC, PVDF, polyamide (PA)/Nylon, thermoplastic polyester elastomers (TPC-ET), or any other such materials. The armor may have a substantially annular ring profile. Once formed, the armor may be substantially watertight. In some implementations, the armor may be oil-resistant, fire-resistant and/or water-resistant, and in many implementations, may be colored or dyed and/or may be printed with one or more identifying characters or labels.

In one example, the armor 104 may comprise a PVDF having a material melt flow rate of 0.5-20 g/10 min. at 230° C. As a result, the armor 104 is suitable for processing in higher stability melt applications. The PVDF may also have a static coefficient of friction of 0.18 to 0.23 and a dynamic coefficient of friction of 0.12 to 0.17 versus steel at 73° F. according to ASTM D 1894 so as to enhance pulling and/or pushing of the armor 104 through a duct or conduit. For example, the PVDF material may comprise Kynar^{®} 1000 or 2850-02.

In another example, the armor 104 may comprise a TPC-ET having a material melt flow rate of 12.5 g/10 min. at 240° C. As a result, the armor 104 is suitable for processing in higher stability melt applications. The TPC-ET may also have a static coefficient of friction of 0.28 to 0.44 and a dynamic coefficient of friction of 0.22 to 0.32 versus steel at 73° F. according to ASTM D 1894 so as to enhance pulling and/or pushing of the armor 104 through a duct or conduit. For example, the TPC-ET material may comprise Hytrel^{®} 7246.

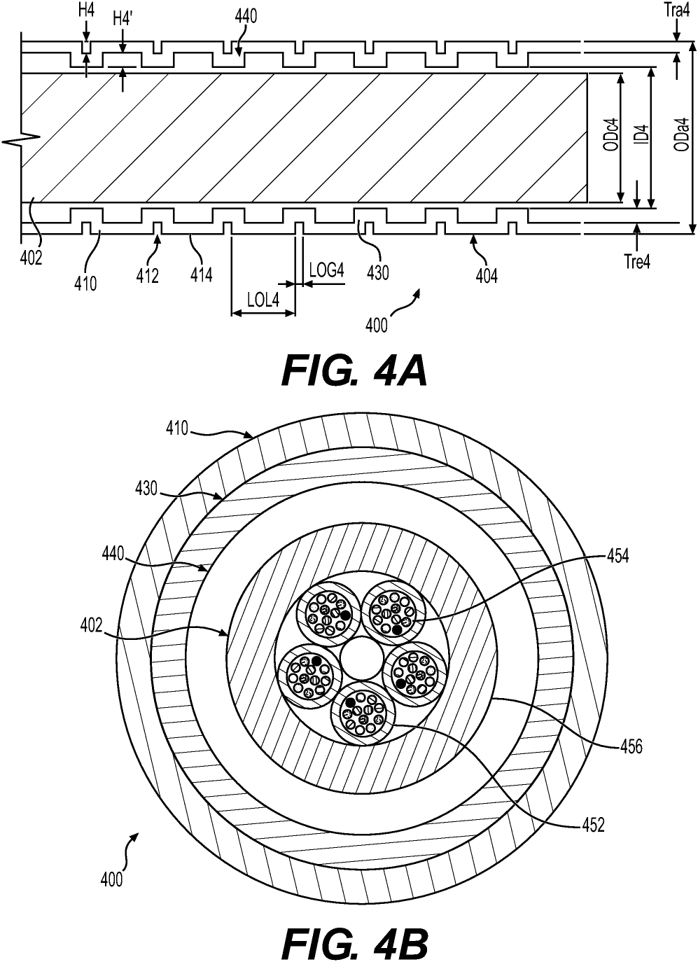

Referring now to FIGS. 4A and 4B, an exemplary cable 400 in accordance with various aspects of the disclosure includes a cable core 402 and a corrugated dielectric armor or jacket 404. The cable core 402 comprises a loose tube fiber cable including a plurality of loose tubes 452 each containing a plurality of individual loose fibers 454 and a jacket 456 surrounding the loose tubes 452. The cable core 402 has an outside diameter ODc4, and the corrugated dielectric armor 404 has an outer diameter Oda4. A radial thickness of raised portions 410 is Tra4, and the radial thickness of recessed portions 430 is Tre4. The raised portions 410 and recessed portions 430 overlap one another in the longitudinal direction and an end of a raised portion 410 is connected to an end of recessed portion 430 by a radial wall 440. The radial wall 440 extends perpendicular to a longitudinal axis of the corrugated armor 404 when the corrugated armor 404 is in a straight (i.e., unbent) configuration and is configured to provide the corrugated armor 404 with improved or enhanced crush resistance relative to conventional armored cable. In addition, the exterior grooves 412, the interior grooves 432, and/or the radial wall 440 are configured to provide the corrugated armor 404 with an improved or enhanced crush resistance-to-weight ratio relative to conventional armored cable.

As noted above, the heights H4, H4′ of the exterior grooves 412 and interior grooves 432 may be different from the radial thickness of the raised portions 410 and recessed portions 430. Thus, an inside diameter ID4 defined by the recessed portions 430 is equal to the outer diameter Oda4 of the armor 404 minus the combined dimensions of the thickness Tra4 of the raised portion 410 and the height H4′ of the interior groove 432 (Oda4 — (Tra4 + H4′)) or the outer diameter Oda4 of the armor 404 minus the combined dimensions of the thickness Tre4 of the recessed portion 430 and the height H4 of the exterior groove 412 (Oda4 — (Tre4 + H4)). The difference between the inside diameter ID4 of the recessed portions 430 and the outside diameter ODc4of the cable core 402 provides an annular space 440 configured to receive, for example, water blocking yarns or strength yarns for use in installation. The length LOL4 of exterior lands 414 is greater than the length LOG4 of exterior grooves 412.

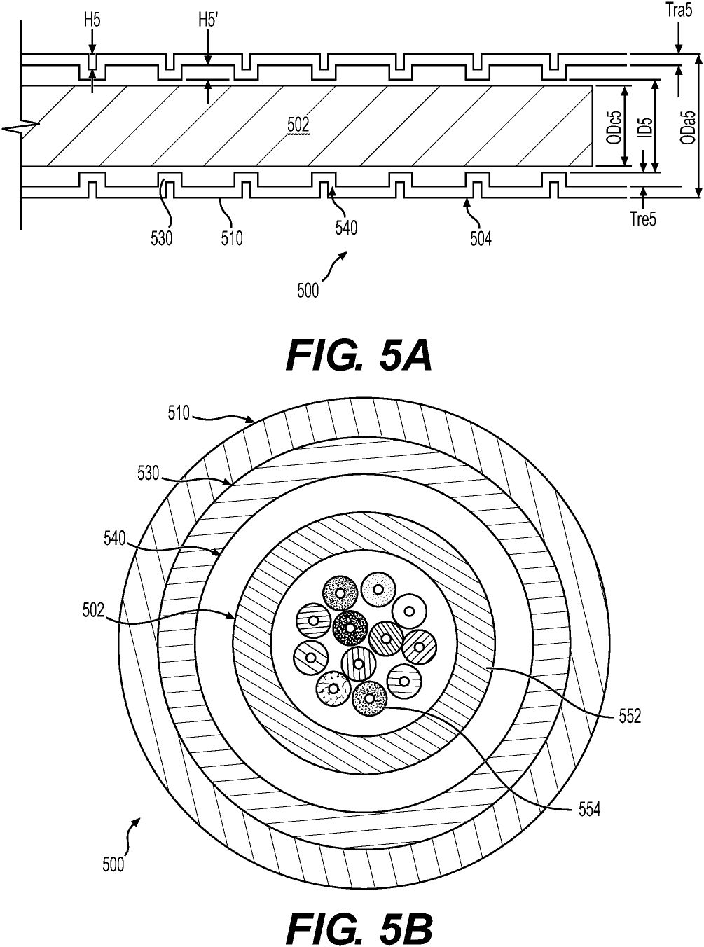

Referring now to FIGS. 5A and 5B, an exemplary cable 500 in accordance with various aspects of the disclosure includes a fiber cable core 502 and a corrugated dielectric armor or jacket 504. The cable core 502 comprises a distribution cable including a tubular member 552 containing a plurality of fibers 554. The cable core 502 has an outside diameter OD-C5, and the corrugated dielectric armor 504 has an outer diameter Oda5. A radial thickness of raised portions 510 is Tra5, and the radial thickness of recessed portions 530 is Tre5. The raised portions 510 and recessed portions 530 overlap one another in the longitudinal direction and an end of a raised portion 510 is connected to an end of recessed portion 530 by a radial wall 540. The radial wall 540 extends perpendicular to a longitudinal axis of the corrugated armor 504 when the corrugated armor 504 is in a straight (i.e., unbent) configuration and is configured to provide the corrugated armor 504 with improved or enhanced crush resistance relative to conventional armored cable. In addition, the exterior grooves 512, the interior grooves 532, and/or the radial wall 540 are configured to provide the corrugated armor 504 with an improved or enhanced crush resistance-to-weight ratio relative to conventional armored cable.

As noted above, the heights H5, H5′ of the exterior grooves 512 and interior grooves 532 may be different from the radial thickness of the raised portions 510 and recessed portions 530. Thus, an inside diameter ID5 defined by the recessed portions 530 is equal to the outer diameter Oda5 of the armor 504 minus the combined dimensions of the thickness Tra5 of the raised portion 510 and the height H5′ of the interior groove 532 (Oda5 — (Tra5 + H5′)) or the outer diameter Oda5 of the armor 504 minus the combined dimensions of the thickness Tre5 of the recessed portion 530 and the height H5 of the exterior groove 512 (Oda5 — (Tre5 + H5)). The difference between the inside diameter ID5 of the recessed portions 530 and the outside diameter ODc5of the cable core 502 provides an annular space 540 configured to receive, for example, water blocking yarns or strength yarns for use in installation.

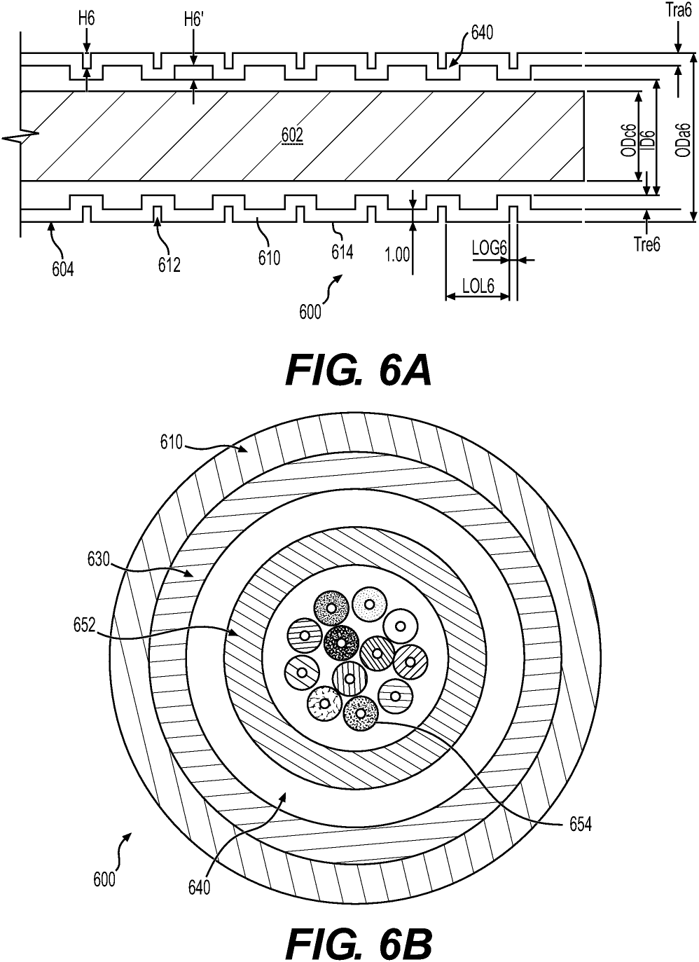

Referring now to FIGS. 6A and 6B, an exemplary cable 600 in accordance with various aspects of the disclosure includes a tight buffer cable core 602 and a corrugated dielectric armor or jacket 604. The cable core 602 comprises a distribution cable including a tubular member 652 containing a plurality of fibers 654. The cable core 602 has an outside diameter OD-C6, and the corrugated dielectric armor 604 has an outer diameter Oda6. A radial thickness of raised portions 610 is Tra6, and the radial thickness of recessed portions 630 is Tre6. The raised portions 610 and recessed portions 630 overlap one another in the longitudinal direction and an end of a raised portion 610 is connected to an end of recessed portion 630 by a radial wall 640. The radial wall 640 extends perpendicular to a longitudinal axis of the corrugated armor 604 when the corrugated armor 604 is in a straight (i.e., unbent) configuration and is configured to provide the corrugated armor 604 with improved or enhanced crush resistance relative to conventional armored cable. In addition, the exterior grooves 612, the interior grooves 632, and/or the radial wall 640 are configured to provide the corrugated armor 604 with an improved or enhanced crush resistance-to-weight ratio relative to conventional armored cable.

As noted above, the heights H6, H6′ of the exterior grooves 612 and interior grooves 632 may be different from the radial thickness of the raised portions 610 and recessed portions 630. Thus, an inside diameter ID6 defined by the recessed portions 630 is equal to the outer diameter Oda6 of the armor 604 minus the combined dimensions of the thickness Tra6 of the raised portion 610 and the height H6′ of the interior groove 632 (Oda6 — (Tra6 + H6′)) or the outer diameter Oda6 of the armor 604 minus the combined dimensions of the thickness Tre6 of the recessed portion 630 and the height H6 of the exterior groove 612 (Oda6 — (Tre6 + H6)). The difference between the inside diameter ID of the recessed portions 630 and the outside diameter ODc6of the cable core 602 provides an annular space 640 configured to receive, for example, water blocking yarns or strength yarns for use in installation. A length LOL6 of exterior lands 614 is greater than a length LOG6 of exterior grooves 612.

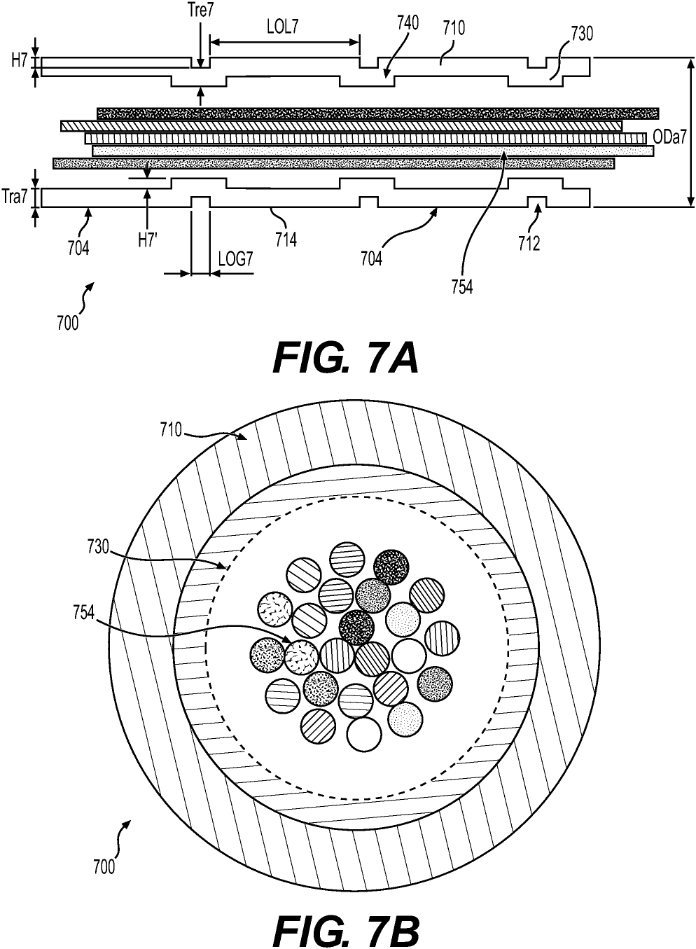

Referring now to FIGS. 7A and 7B, an exemplary cable 700 in accordance with various aspects of the disclosure a corrugated dielectric armor or jacket 704 surrounding a plurality of loose fibers 754. The cable 700 is an example of an indoor mini fiber cable. The corrugated dielectric armor 704 has an outer diameter Oda7, a radial thickness of raised portions Tra7, a radial thickness of recessed portions Tre7, and a height H7 of exterior grooves 712. The raised portions 710 and recessed portions 730 overlap one another in the longitudinal direction and an end of a raised portion 710 is connected to an end of recessed portion 730 by a radial wall 740. The radial wall 740 extends perpendicular to a longitudinal axis of the corrugated armor 704 when the corrugated armor 704 is in a straight (i.e., unbent) configuration and is configured to provide the corrugated armor 704 with improved or enhanced crush resistance relative to conventional armored cable. In addition, the exterior grooves 712, the interior grooves 732, and/or the radial wall 740 are configured to provide the corrugated armor 704 with an improved or enhanced crush resistance-to-weight ratio relative to conventional armored cable.

As noted above, the heights H7, H7′ of the exterior grooves 712 and interior grooves 732 may be different from the radial thickness of the raised portions 710 and recessed portions 730. Thus, an inside diameter ID7 defined by the recessed portions 730 is equal to the outer diameter Oda7 of the armor 704 minus the combined dimensions of the thickness Tra7 of the raised portion 710 and the height H7′ of the interior groove 732 (Oda7 — (Tra7 + H7′)) or the outer diameter Oda7 of the armor 704 minus the combined dimensions of the thickness Tre7 of the recessed portion 730 and the height H7 of the exterior groove 712 (Oda7 — (Tre7 + H7)). Thus, an inside diameter ID defined by the recessed portions 730 provides space for receiving, for example, water blocking yarns or strength yarns for use in installation. The length LOL7 of exterior lands 714 is greater than the length LOG7 of the exterior grooves 712.

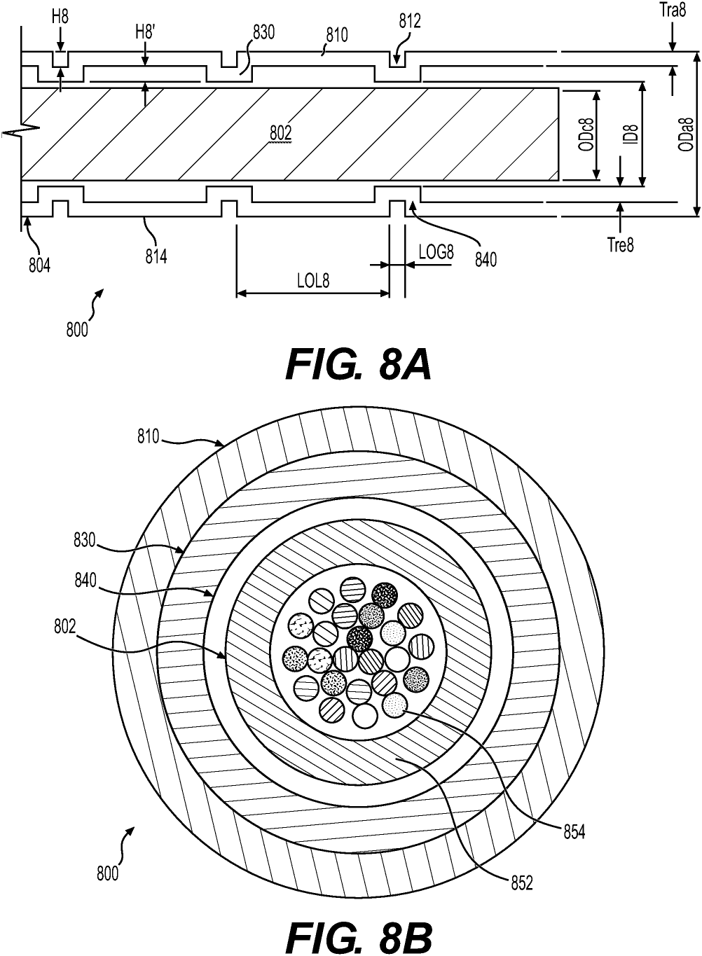

Referring now to FIGS. 8A and 8B, an exemplary cable 800 in accordance with various aspects of the disclosure includes a fiber cable core 802 and a corrugated dielectric armor or jacket 804. The cable core 802 comprises a mini-round fiber cable including a tubular member 852 containing a plurality of fibers 854. The cable core 802 has an outside diameter ODc8, and the corrugated dielectric armor 804 has an outer diameter ODa8. A radial thickness of raised portions 810 is Tra8, and the radial thickness of recessed portions 830 is Tre8. The raised portions 810 and recessed portions 830 overlap one another in the longitudinal direction and an end of a raised portion 810 is connected to an end of recessed portion 830 by a radial wall 840. The radial wall 840 extends perpendicular to a longitudinal axis of the corrugated armor 804 when the corrugated armor 804 is in a straight (i.e., unbent) configuration and is configured to provide the corrugated armor 804 with improved or enhanced crush resistance relative to conventional armored cable. In addition, the exterior grooves 812, the interior grooves 832, and/or the radial wall 840 are configured to provide the corrugated armor 804 with an improved or enhanced crush resistance-to-weight ratio relative to conventional armored cable.

As noted above, the heights H8, H8′ of the exterior grooves 812 and interior grooves 832 may be different from the radial thickness of the raised portions 810 and recessed portions 830. Thus, an inside diameter ID8 defined by the recessed portions 830 is equal to the outer diameter Oda8 of the armor 804 minus the combined dimensions of the thickness Tra8 of the raised portion 810 and the height H8′ of the interior groove 832 (Oda8 — (Tra8 + H8′)) or the outer diameter Oda8 of the armor 804 minus the combined dimensions of the thickness Tre8 of the recessed portion 830 and the height H8 of the exterior groove 812 (Oda8 — (Tre8 + H8)). The difference between the inside diameter ID8 of the recessed portions 830 and the outside diameter ODc8 of the cable core 802 provides an annular space 840 configured to receive, for example, water blocking yarns or strength yarns for use in installation. The length LOL8 of exterior lands 814 is greater than the length LOG8 of exterior grooves 812.

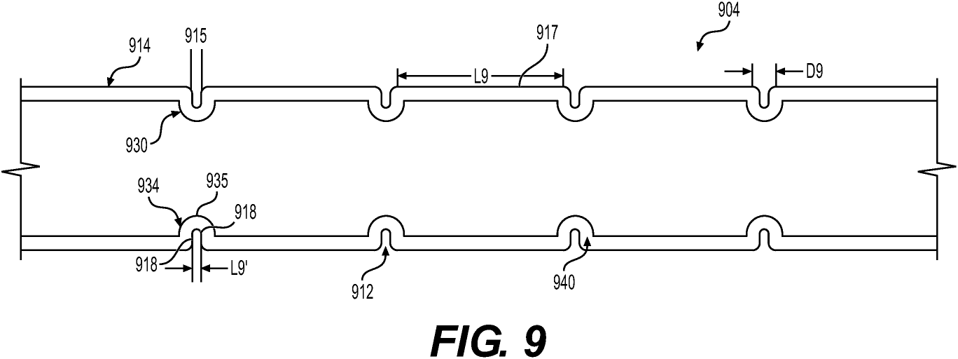

Referring to FIG. 9, it should be appreciated that, in some aspects, a corrugated dielectric armor 904 similar to armor 104 may include exterior lands 914 and interior lands 934 having rounded corners 915, 935, respectively. The rounded corners 915, 935 may aid in releasing the armor 904 from a mold. In aspects where the recessed portion 930 is completely rounded (i.e., no flat portion), the land length L9′ is the distance between radial walls 918 that define the exterior grooves 912. In some aspects, a length L9 of a flat portion 917 of the exterior lands 914 is greater than a distance D9 between the rounded corners 915 that are above the interior lands 934. The exterior lands 914 and interior lands 934 are connected to one another by a radial wall 940. The radial wall 940 extends perpendicular to a longitudinal axis of the corrugated armor 904 when the corrugated armor 904 is in a straight (i.e., unbent) configuration and is configured to provide the corrugated armor 904 with improved or enhanced crush resistance relative to conventional armored cable. In addition, the exterior grooves 912, the interior grooves 932, and/or the radial wall 940 are configured to provide the corrugated armor 904 with an improved or enhanced crush resistance-to-weight ratio relative to conventional armored cable.

Accordingly, aspects of the corrugated dielectric armor cables discussed herein provide for cables with non-uniform profiles or corrugations. The disclosed aspects may allow for multiple material types to be used and may accommodate much larger armor sizes and/or cables than convention armored cables. The disclosed aspects may provide a cable with corrugated dielectric armor configured to provide improved crush resistance relative to conventional armored cable. The disclosed aspects may provide a cable with corrugated dielectric armor having a greater range of cable size (smaller and/or larger) relative to conventional armored cable. The disclosed aspects may provide a cable with corrugated dielectric armor configured to be produced in fewer process steps, with versatile processing speeds, with different jacket materials, and/or with a reduced amount of extrusion material relative to conventional armored cable. The disclosed aspects may provide a cable having reduced material usage and weight with improved flexibility relative to a solid jacketed armor and/or reduced weight and increased flexibility compared to a conventional metallic armored cable. The disclosed aspects may provide a cable with corrugated dielectric armor having improved lifespan relative to conventional armored cable.

The above description in conjunction with the above-reference drawings sets forth a variety of embodiments for exemplary purposes, which are in no way intended to limit the scope of the described cables. Those having skill in the relevant art can modify the described cables in various ways without departing from the broadest scope of the described cables. Thus, the scope of the cables described herein should not be limited by any of the exemplary embodiments and should be defined in accordance with the accompanying claims and their equivalents.

What is claimed:

1. An armored cable, comprising:
a cable core including at least one transmission element;
a corrugated dielectric armor configured to surround the cable core;
wherein the at least one transmission element includes an optical fiber or a conductor;
wherein the corrugated dielectric armor comprises a material having a melt flow rate of 0.5-20 g/10 min. at 230° C. to 240° C. so as to permit the corrugated dielectric armor to be used in higher stability melt applications;
wherein the material of the corrugated dielectric armor comprises a static coefficient of friction of 0.18 to 0.44 and a dynamic coefficient of friction of 0.12 to 0.32 versus steel at 73° F. so as to enhance pulling and/or pushing of the corrugated dielectric armor during installation;
wherein the corrugated dielectric armor is configured to include raised portions and recessed portions along a length of the cable;
wherein the raised portions are configured to be separated from one another by exterior grooves, the recessed portions are configured to be separated from one another by interior grooves, and the exterior grooves are configured to have a groove length in the longitudinal direction;
wherein each of the raised portions is configured to include an exterior land having a land length, and the exterior lands are configured to delimit an outer diameter of the corrugated dielectric armor;
wherein each of the recessed portions is configured to include an interior land, and the interior lands are configured to delimit an inner diameter of the corrugated dielectric armor;
wherein the land length of the raised portions is configured to be greater than the groove length of the exterior grooves so as to prevent nesting of the cable;
wherein opposing corners of adjacent raised portions are configured to define bend limiting contact points that are configured to contact one another when the cable is bent so as to limit a degree to which the cable can be bent to a desired bend radius;
wherein one of the raised portions is connected to one of the recessed portions by a radial wall that is configured to extend perpendicular to a longitudinal axis of the corrugated dielectric armor when the corrugated dielectric armor is in a straight configuration; and
wherein the radial wall is configured to provide the corrugated dielectric armor with enhanced crush resistance.

2. The armored cable of claim 1, wherein the material of the corrugated dielectric armor comprises a polyvinylidene fluoride (PVDF) having a material melt flow rate of 0.5-20 g/10 min. at 230° C.

3. The armored cable of claim 1, wherein the material of the corrugated dielectric armor comprises a polyvinylidene fluoride (PVDF) having a static coefficient of friction of 0.18 to 0.23 and a dynamic coefficient of friction of 0.12 to 0.17 versus steel at 73° F.

4. The armored cable of claim 1, wherein the material of the corrugated dielectric armor comprises a thermoplastic polyester elastomer (TPC-ET) having a material melt flow index of 12.5 g/10 min. at 240° C.

5. The armored cable of claim 1, wherein the material of the corrugated dielectric armor comprises a thermoplastic polyester elastomer (TPC-ET) having a static coefficient of friction of 0.28 to 0.44 and a dynamic coefficient of friction of 0.22 to 0.32 versus steel at 73° F.

6. An armored cable, comprising:
a cable core including at least one transmission element;
a corrugated dielectric armor configured to surround the cable core;
wherein the corrugated dielectric armor is configured to include raised portions and recessed portions along a length of the cable;
wherein the raised portions are configured to be separated from one another by exterior grooves, the recessed portions are configured to be separated from one another by interior grooves, and the exterior grooves are configured to have a groove length in the longitudinal direction;
wherein a land length of the raised portions is configured to be greater than the groove length of the exterior grooves so as to prevent nesting of the cable;
wherein opposing corners of adjacent raised portions are configured to define bend limiting contact points that are configured to contact one another when the cable is bent so as to limit a degree to which the cable can be bent to a desired bend radius;
wherein one of the raised portions is connected to one of the recessed portions by a radial wall that is configured to extend perpendicular to a longitudinal axis of the corrugated dielectric armor when the corrugated dielectric armor is in a straight configuration; and
wherein the radial wall is configured to provide the corrugated dielectric armor with enhanced crush resistance.

7. The armored cable of claim 6, wherein the corrugated dielectric armor comprises a polyvinylidene fluoride (PVDF) having a material melt flow rate of 0.5-20 g/10 min. at 230° C. so as to permit the corrugated dielectric armor to be used in higher stability melt applications.

8. The armored cable of claim 6, wherein the corrugated dielectric armor comprises a polyvinylidene fluoride (PVDF) having a static coefficient of friction of 0.18 to 0.23 and a dynamic coefficient of friction of 0.12 to 0.17 versus steel at 73° F. so as to enhance pulling and/or pushing of the corrugated dielectric armor during installation.

9. The armored cable of claim 6, wherein the corrugated dielectric armor comprises a thermoplastic polyester elastomer (TPC-ET) having a material melt flow index of 12.5 g/10 min. at 240° C. so as to permit the corrugated dielectric armor to be used in higher stability melt applications.

10. The armored cable of claim 6, wherein the corrugated dielectric armor comprises a thermoplastic polyester elastomer (TPC-ET) having a static coefficient of friction of 0.28 to 0.44 and a dynamic coefficient of friction of 0.22 to 0.32 versus steel at 73° F. so as to enhance pulling and/or pushing of the corrugated dielectric armor during installation.

11. The armored cable of claim 6, wherein the at least one transmission element includes an optical fiber or a conductor.

12. The armored cable of claim 6, wherein each of the raised portions is configured to include an exterior land, and the exterior lands are configured to delimit an outer diameter of the corrugated dielectric armor; and
wherein each of the recessed portions is configured to include an interior land, and the interior lands are configured to delimit an inner diameter of the corrugated dielectric armor.

13. An armored cable, comprising:
a cable core including at least one transmission element;
a corrugated armor configured to surround the cable core;
wherein the corrugated armor is configured to include raised portions and recessed portions along a length of the cable;
wherein the raised portions are configured to be separated from one another by exterior grooves, and the recessed portions are configured to be separated from one another by interior grooves;
wherein one of the raised portions is connected to one of the recessed portions by a radial wall that is configured to provide the corrugated armor with enhanced crush resistance.

14. The armored cable of claim 13, wherein the corrugated armor comprises a polyvinylidene fluoride (PVDF) having a material melt flow rate of 0.5-20 g/10 min. at 230° C. so as to permit the corrugated armor to be used in higher stability melt applications.

15. The armored cable of claim 13, wherein the corrugated armor comprises a polyvinylidene fluoride (PVDF) having a static coefficient of friction of 0.18 to 0.23 and a dynamic coefficient of friction of 0.12 to 0.17 versus steel at 73° F. so as to enhance pulling and/or pushing of the corrugated armor =during installation.

16. The armored cable of claim 13, wherein the corrugated armor comprises a thermoplastic polyester elastomer (TPC-ET) having a material melt flow index of 12.5 g/10 min. at 240° C. so as to permit the corrugated armor to be used in higher stability melt applications.

17. The armored cable of claim 13, wherein the corrugated armor comprises a thermoplastic polyester elastomer (TPC-ET) having a static coefficient of friction of 0.28 to 0.44 and a dynamic coefficient of friction of 0.22 to 0.32 versus steel at 73° F. so as to enhance pulling and/or pushing of the corrugated armor during installation.

18. The armored cable of claim 13, wherein the at least one transmission element includes an optical fiber or a conductor.

19. The armored cable of claim 13, wherein each of the raised portions is configured to include an exterior land, and the exterior lands are configured to delimit an outer diameter of the corrugated armor; and
wherein each of the recessed portions is configured to include an interior land, and the interior lands are configured to delimit an inner diameter of the corrugated armor.

20. The armored cable of claim 13, wherein the exterior grooves are configured to have a groove length in the longitudinal direction; and
wherein a land length of the raised portions is configured to be greater than the groove length of the exterior grooves so as to prevent nesting of the cable;.

21. The armored cable of claim 13, wherein opposing corners of adjacent raised portions are configured to define bend limiting contact points that are configured to contact one another when the cable is bent so as to limit a degree to which the cable can be bent to a desired bend radius.

22. The armored cable of claim 13, wherein the corrugated armor comprises a corrugated dielectric armor.
